(19) United States
(12) Patent Application Publication
(10) Pub. No.: US 2007/0001808 A1
(43) Pub. Date: Jan. 4, 2007

(54) Identification system for identifying objects

(75) Inventors: Michael Kastelic, Wein (AT); Katja Kienzl, Graz (AT); Matthias Weitlaner, Lieboch (AT)

Correspondence Address: DICKSTEIN SHAPIRO LLP, 1177 AVENUE OF THE AMERICAS (6TH AVENUE), NEW YORK, NY, 10036-2714, US

(73) Assignee: Infineon Technologies AG, Munich (DE)

(21) Appl. No.: 11/285,787

(22) Filed: Nov. 21, 2005

(30) Foreign Application Priority Data
Nov. 19, 2004 (DE) 10 2004 055 920.1

(51) Int. Cl. H04Q 5/22

(52) U.S. Cl. 340/10.1; 340/10.32; 340/572.1; 340/5.92; 235/385

(57) ABSTRACT

An identification system for identifying objects, according to one embodiment, includes a plurality of objects to be identified within an area, with a transponder being fitted to one respective object and operable to transmit a code radio frequency signal representing an identification code. The system includes an activation part that is remote from the respective object and is operable to transmit an activation radio frequency signal via a wireless connection to the transponder of the respective object so that the transmitting part transmits the code radio frequency signal. A receiving part that is remote from the respective object is operable to receive the code radio frequency signal via a wireless connection. The system also includes a device that is operable to move the activation part and receiving part within the area such that the two parts are moved continuously along a predetermined path which is in the form of circulatory path that is complementary to a shape of the area and to an arrangement of the objects in the area and such that activation part and the receiving part are moved past each respective object.

The invention relates to an identification system for identifying objects in areas, in particular stationary objects in closed areas.

It is often desirable, in working areas and/or storage areas such as office areas, storage containers etc., to be able to rapidly and, if appropriate, continuously monitor the inventory stock there such as, in particular, the equipment (computer systems, printer devices, monitors, cupboards, tables, chairs etc.) and/or any goods/products stored therein (devices, textiles, furniture, packaging boxes etc.) in order thereby to be able to carry out stocktaking, for example, in a faster manner.

WO 01/06401 A1 describes a mobile RFID tag reading device for tracking RFID tags (Radio Frequency Identification Tags). In this case, RFID tags are fitted to stationary or movable objects and communicate with the RFID reading device. Communication provides a central or remote control device with information about the identity, the position and/or the status of the tags and objects. The absolute position of the objects which have been provided with tags can be determined by the mobile tag reading device or the central control device, and the absolute position of the mobile reading device can be ascertained by communicating with tags at defined known locations.

U.S. Pat. No. 4,862,160 describes an object identification tag for a system for stocktaking goods on shelves. In this case, a computer-controlled mobile transceiver repeatedly scans a large number of trans-mission/reception frequencies in order to jointly interrogate a plurality of groups of objects in a storage area. The objects in each group are provided with a circuit transponder which is tuned to frequencies which are uniquely assigned to the group. The data which are returned are stored by the computer and mathematically combined in order to obtain the total number of objects in each group.

The invention provides an identification system for identifying objects in rooms, which system can be used to detect the objects rapidly and simply and nevertheless with a high degree of precision and can be implemented in a cost-effective manner.

The inventive identification system for identifying objects, in particular stationary objects, in rooms such as, in particular, closed rooms has: a transponder which is fitted to the respective object to be identified in the room and can be interrogated for an identification code using a radiofrequency signal which is emitted by the reader installed in the room. In this case, the reader which is installed in the room, in particular the antenna(s) of the reader, is (are) constantly moved.

Microcontrollers having a connected antenna on a carrier material may be used as transponders, in which case the microcontroller is supplied with power by the radiofrequency field, actively replies to the reader with its identification code and, as an additional option, can be programmed using the radiofrequency field. In accordance with the requirements, the entire transponder is (may be) also surrounded by a protective plastic housing.

Provision may also be made of paper-thin transponder designs in which the transponder antennas are applied to a carrier material using various methods.

The reader is preferably a reader which is customary in UHF RFID technology and operates, in particular, in the frequency range of 860 MHz to 950 MHz, other appropriate frequency ranges such as ultra-high frequency of 300 MHz to 3 GHz or else microwave frequencies of greater than 3 GHz also being conceivable, however, depending on the desired range which is preferably between 0.01 m and 10 m. The associated transponder operates at a frequency which matches that of the reader.

Provision is particularly preferably made of a passive transponder which obtains its electrical operating power by means of the activation radiofrequency signal which additionally also comprises the activation information that stimulates the transponder to transmit the code associated with the latter.

The use of such a UHF RFID system affords the advantage, in principle, that the respective reader does not have to be in uninterrupted visual contact with the associated transponder, as is the case, for example, in a barcode system. The reader can thus be led past the transponder with a certain degree of variability in terms of its distance and alignment in order to be able to nevertheless reliably identify the transponder.

In this case, the reader continuously emits an item of activation information over a particular range in the form of the activation radiofrequency signal, and the activation radiofrequency signal, as explained above, then stimulates a transponder which is detected by said activation radiofrequency signal and is otherwise not emitting any radio signals. Provided in the transponder is a memory device, in particular in the form of a microchip (in particular having a memory and a microprocessor) which stores, in its memory, an item of code information which (preferably uniquely) characterizes the transponder and is then emitted in the form of said code radiofrequency signal upon stimulation of the reader by the activation radiofrequency signal.

In addition to the preferred passive type of transponder, the transponder may, however, also be provided such that it is active, the latter than having a battery and obtaining the requisite electrical operating power for operating the microcontroller and/or the data storage medium. In this case, the activation radiofrequency signal received is used to activate the microcontroller.

The code radiofrequency signal emitted is, after the transponder has impressed its data on the signal, received by the reception part which is arranged, in particular, adjacent to the activation part. The reception part and the activation part are preferably provided in one unit, for example in the form of two antennas in one housing, one of which forms the activation part and the other of which forms the reception part, both the reception part and the activation part being connected or being able to be connected, in this case, to a control device such as, in particular, a microprocessor, which generates or processes and evaluates the respective frequency signals which are transmitted/received.

It is also possible for the activation part and the reception part to be provided in the form of a single unit, that is to say, for example, in the form of a single antenna. In this case, this one antenna is also used to continuously operate the activation part for power transmission, and the same antenna is simultaneously used to receive the signal from the transponder.

Up to four activation and reception parts may typically be operated on one reader. Said parts are then operated in multiplex mode, and only one activation part and one reception part are ever in use.

The movement device which continuously moves the activation part and the reception part in the area results in the activation part and the reception part being arranged at different distances from, and in different alignments with respect to, the respective object and its transponder. This results, with a very high degree of probability, in a relative position and relative alignment—which are favorable for the correct transmission of power and radio data—between the reception part/activation part and the transponder. Interference which occurs, for example, on account of a lack of electromagnetic stimulation/reception owing to alignment congruence between the activation part/reception part and the transponder is thus avoided to the greatest possible extent. This also avoids, to the greatest possible extent, the risk of interference as a result of radio signal reflection, which varies depending on the shape of the area and depending on the shape and arrangement of the objects and depending on the relative position between the activation part/reception part and the object/transponder, since, on account of the movement device, a favorable relative position between the activation part/reception part and the object/transponder will be achieved, with a high degree of probability, even in view of such reflection effects.

This achieves the desired high level of reliability as regards reliably identifying the respective object. The system is nonetheless simple to implement since the movement device, as also explained below, is relatively simple to implement. The movement device can be provided in a particularly simple manner if the reception part and the activation part are integrated in one unit. If the reception part and the activation part are provided separately, the movement device is configured in such a manner that the reception part and the activation part are moved synchronously, in which case it must be ensured that the respective object also simultaneously, i.e. in an overlapping manner, comes to lie in the transmission range of the activation part and in the reception range of the reception part. In this case, the activation part and the reception part are preferably successively moved adjacent to one another on the same path or are moved parallel to one another on adjacent paths.

Although the reception part and the activation part may also be respectively moved, in principle, through the area in a manner governed by chance, for example in the form of a carriage which moves on the floor and automatically changes direction as desired when it bumps into an object or a wall, the reception part and the activation part are preferably moved by the movement device in a controlled manner along a predetermined path at a predetermined speed. In this case, depending on the condition of the room and of the objects accommodated/to be accommodated therein, the respective path may be adapted in such a manner that each region in the room is detected by the reception part/activation part over a certain section of the path by means of the activation part and the reception part which are moved along their path, provision preferably being made of only one single path along which both the reception part and the activation part are moved.

The speeds of less than or equal to 30 cm/s, preferably less than or equal to 15 cm/s, particularly preferably approximately 10 cm/s were determined to be advantageous speeds of movement for the activation part and the reception part. A sufficiently reliable identification process is provided at these speeds, larger rooms nevertheless also being able to be covered in an appropriate amount of time and the objects in said room thus being able to be detected in a sufficiently rapid and precise manner.

Suitable predetermined paths, in particular in a plane, particularly a horizontal plane, are existing simple paths such as a linear path, along which the reception part/activation part is moved back and forth, a circular path, along which the reception part/activation part is continuously moved back and forth in a circulating manner or else respectively through 360°, or other simple annular paths such as triangular or rectangular or other polygonal paths along which the reception part/activation part is continuously moved back and forth in a circulating manner or else between the start/end of the path. However, depending on the room or else in buildings having a plurality of rooms, in particular over a plurality of stories, complicated forms of path are also conceivable, said paths having any desired three-dimensional structures which are respectively matched to the existing shape of the room and arrangement of objects.

Although it suffices, for example, to move the reception part/transponder to only one or the other object such as, in particular, at the end of a linear path, the movement device is preferably configured in such a manner that the reception part/activation part is moved past the respective object. That is to say, for example, the path should always be extended somewhat beyond the position of objects which is to be expected.

In particular, rail systems along which the reception part/activation part is guided are preferred as the path. However, cable, belt and/or chain transport systems are also conceivable as the movement device. Ground transport vehicles which cover the predetermined path under radio control and, in the event of a fault, are automatically led back to this path again are also conceivable. In this case, navigation devices such as GPS may also be suitable for guiding the ground transport vehicles. A ground vehicle system of this type may be advantageous, in particular, in very large storage halls in which long rail systems would entail a cost disadvantage.

The invention also relates to an identification facility having an identification system as explained above as well as the area, in particular the building or the container, in which the area is provided.

The invention is explained below using preferred embodiments and with reference to the drawing, in which:

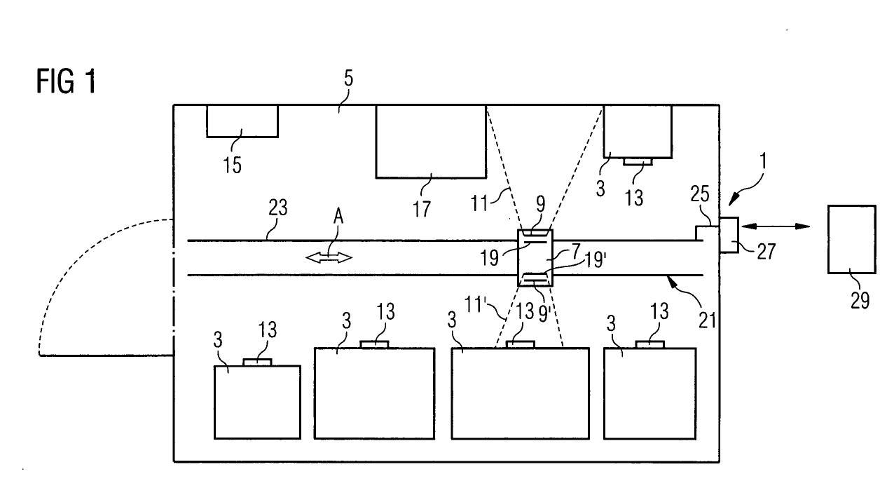

FIG. 1 shows an identification system in accordance with a first embodiment of the invention,

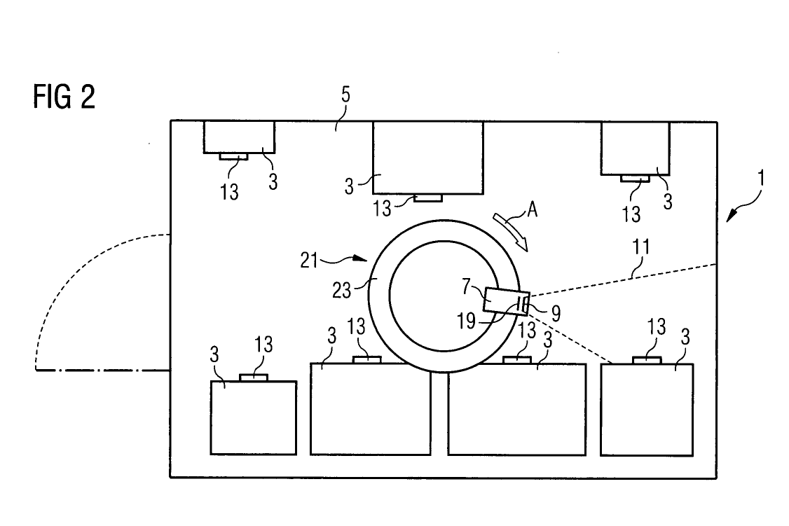

FIG. 2 shows an identification system in accordance with a second embodiment of the invention, and

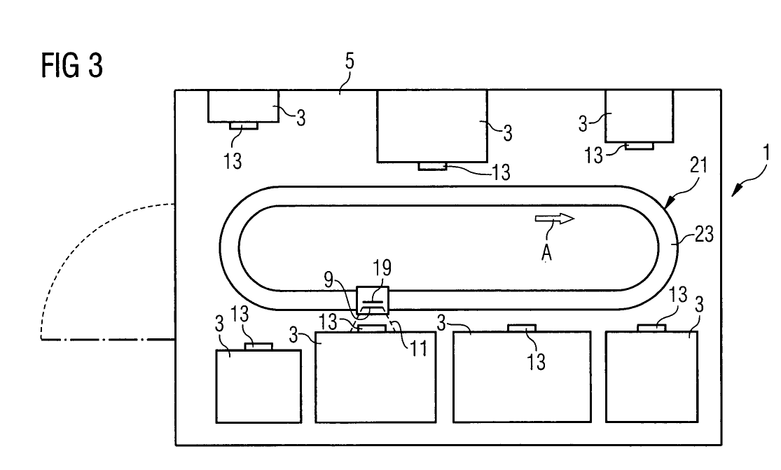

FIG. 3 shows an identification system in accordance with a third embodiment of the invention.

In the figures, the same reference symbols are used for essentially identical features.

In accordance with a first exemplary embodiment of the invention, the identification system 1 which is illustrated in FIG. 1 and is intended to identify objects 3 in areas 5 has an activation part/reception part unit 7 in the form of a box-shaped body. The activation part/reception part unit 7 has two activation parts 9, 9′ which are arranged on opposite end sections of the unit 7, are in the form of a respective directional antenna and can transmit an activation radiofrequency signal without using cables in respective opposite directions. The antenna is preferably a linearly polarized antenna (preferably having a gain of 5 dB) or alternatively a circularly polarized antenna (preferably having a gain of 8 dB or 9.5 dB). The transmission range 11, 11′ of the respective activation part 9, 9′ is indicated using dashed lines. In the present example, the objects 3 are items of equipment of a telecommunications system such as, in particular, modems, distribution boxes, switching devices etc. The area 5 which is rectangular in this case in the plan view is formed by a container.

The identification system 1 also has a transponder 13 which is fitted, in a fixed or detachable manner, to the respective object 3 to be identified and transmits a code radiofrequency signal that represents an identification code when it receives the activation radiofrequency signal emanating from an activation part 9, 9′. An RFID tag from the company Rafsec having a U-Code EPC 1, 19 chip from the company Philips is preferably used as the transponder 13.

Apart from that, a fuse box 15 and a table 17 which are not intended to be identified in this case are also arranged in the room.

The identification system 1 also has two respective reception parts 19, 19′ which are integrated in the activation part/reception part unit 7, are in the form of a respective directional antenna, are arranged adjacent to the respective associated activation part 9, 9′ and the reception range of which essentially corresponds to the transmission range 11, 11′ of the associated activation part 9, 9′.

The identification system 1 also has a movement device 21 in the form of a guide path 23 which comprises two rails (which run parallel) and runs essentially in a straight line along the longitudinal center of the area 5 on the ceiling of the latter, the guide path 23 extending over virtually the entire length of the room 5 and, at its longitudinal ends, being at only a short distance from the end boundary wall of the room 5. The movement device 21 also has a carriage (not illustrated in any more detail) to which the activation part/reception part unit 7 is fitted and which can be moved along the guide path 23. The movement device 21 also has a drive device (not illustrated) which can move the carriage, together with the activation part/reception part unit 7 fitted to the latter, back and forth along the guide path 23 (double-headed arrow A). In accordance with the exemplary embodiments, the MP9320 EPC V2.7 reader from the company Samsys or the ID ISC.LRV 1000 reader from the company Feig is used as the reception part, in other words as the RFID reading unit (RFID reader).

The activation parts 9, 9′ and the reception parts 19, 19′ are arranged in such a manner that they essentially transmit and receive in opposite directions in a direction perpendicular to the guide path 23. Arranging the guide path 23 on the ceiling of the room 5 thus makes it possible for the entire room 5 to be gradually repeatedly detected by the transmission/reception range of the activation part/reception part unit 7.

By virtue of the fact that, in this case, the transponders 13 on the permanently installed objects 3 receive activation radio signals from the respective activation part 9, 9′ from different angles and also return code radiofrequency signals to the respective reception part 19, 19′ in the direction of different angles, a relative alignment—which is favorable for the correct transmission of signals—between the activation part/reception part unit 7 and the respective transponder 13 will be achieved with a very high degree of probability.

In order to process the data which have been acquired by the activation part/reception part unit 7 and to make them clear to the user, the identification system 1 in accordance with this embodiment has the following configuration: the activation part/reception part unit 7 is connected to a communications link device 27 via a data line 25 which partially runs in the guide path 23, which communications link device may be a radio transmitter/radio receiver device or a data cable and is correspondingly connected, for its part, to a control device 29, in particular a microprocessor, without using cables or via a cable connection, which control device may be in the container but, as in the present exemplary embodiment, is preferably provided at a remote location. The data which have been acquired by the activation part/reception part unit 7 are transmitted to the control device 29 using said data line connection, the control device 29 the n evaluating the data and outputting them to the user in appropriately processed form.

The closed room 5 in the container forms, together with the identification system 1 (which has been described and is provided in the latter) and the objects 3, an identification facility in accordance with a first embodiment of the invention.

In accordance with a second exemplary embodiment of the invention, the identification system 1 which is illustrated in FIG. 2 and is intended to identify objects 3 in a room 5 likewise has an activation part/reception part unit 7 in the form of a box-shaped body. The activation part/reception part unit 7 has an activation part 9 which is arranged on an end section of the activation part/reception part unit 7, is in the form of a directional antenna and can transmit an activation radiofrequency signal into the room 5 without using cables. The transmission range 11 of the activation part 9 is indicated using dashed lines. In this example, the objects 3 to be identified are items of equipment in an office such as, in particular, computer systems, cupboards and tables. The room 5 which is rectangular in this case in the plan view is formed by a room in a building.

The identification system 1 also has a transponder 13 which is fitted, in a fixed or detachable manner, to the respective object 3 to be identified and transmits a code radiofrequency signal that represents an identification code when it receives the activation radiofrequency signal emanating from the activation part 9.

The identification system 1 also has a reception part 19 which is integrated in the activation part/reception part unit 7, is in the form of a directional antenna, is arranged adjacent to the activation part 9 on one end section of the activation part/reception part unit 7 and the reception range of which essentially corresponds to the transmission range 11 of the associated activation part 9.

The identification system 1 also has a movement device 21 in the form of a guide path 23 which comprises two rails (which are concentrically arranged and run in a circular manner) and is essentially arranged, as seen in the plan view, in the center of the area 5 on the ceiling of the latter, the diameter of the guide path 23 being somewhat smaller than half the width of the room 5, with the result that said guide path extends at an appropriate distance from the lateral boundary walls of the room 5. The movement device 21 also has a carriage (not illustrated in any more detail) to which the activation part/reception part unit 7 is fitted and which can be moved along the guide path 23. The movement device 21 also has a drive device (not illustrated) which can move the carriage, together with the activation part/reception part unit 7 fitted to the latter, along the guide path 23 (arrow A).

The activation part 9 and the reception part 19 are arranged in such a manner that they essentially transmit and receive radially outward in a direction perpendicular to the guide path 23. Arranging the guide path 23 in the center of the ceiling of the room 5 thus makes it possible for the entire room 5 to be gradually repeatedly detected by the transmission/reception range of the activation part/reception part unit 7.

By virtue of the fact that, in this case, the transponders 13 on the permanently installed objects 3 receive activation radio signals from the activation part 9 from different angles and also return code radiofrequency signals to the reception part 19 in the direction of different angles, a relative alignment—which is favorable for the correct transmission of signals—between the activation part/reception part unit 7 and the transponder 13 will be achieved with a very high degree of probability.

In this case, the data are preferably transmitted from the activation part/reception part unit 7 to a control device as described with reference to the first exemplary embodiment, the corresponding components not being described here.

The closed room 5 in the building forms, together with the identification system 1 (which has been described and is provided in the latter) and the objects 3, an identification facility in accordance with a second embodiment of the invention.

In accordance with a third exemplary embodiment of the invention, the identification system 1 which is illustrated in FIG. 3 and is intended to identify objects 3 in a room 5 likewise has an activation part/reception part unit 7 in the form of a box-shaped body. The activation part/reception part unit 7 has an activation part 9 which is arranged on an end section of the activation part/reception part unit 7, is in the form of a directional antenna and can transmit an activation radiofrequency signal into the room 5 without using cables. The transmission range 11 of the activation part 9 is indicated using dashed lines. In this example, the objects 3 to be identified are goods in a warehouse, for example household goods, textile goods, furniture or the like. The room 5 which is rectangular in this case in the plan view is formed by a storage hall.

The identification system 1 also has a transponder 13 which is fitted, in a fixed or detachable manner, to the respective object 3 to be identified and transmits a code radiofrequency signal that represents an identification code when it receives the activation radiofrequency signal emanating from the activation part 9.

The identification system 1 also has a reception part 19 which is integrated in the activation part/reception part unit 7, is in the form of a directional antenna, is arranged adjacent to the activation part 9 on one end section of the activation part/reception part unit 7 and the reception range of which essentially corresponds to the transmission range 11 of the associated activation part 9.

The identification system 1 also has a movement device 21 in the form of a guide path 23 which comprises two rails (which are concentrically arranged and describe an essentially rectangular path with round longitudinal ends) and is essentially arranged, as seen in the plan view, in the longitudinal center of the room 5 on the ceiling of the latter, the width of the guide path 23 being somewhat narrower than half the width of the room 5 and the length of the guide path being somewhat shorter than the length of the room 5, with the result that said guide path extends at an appropriate distance from the lateral boundary walls of the room 5. The movement device 21 also has a carriage (not illustrated in any more detail) to which the activation part/reception part unit 7 is fitted and which can be moved such that it is guided along the guide path 23. The movement device 21 also has a drive device (not illustrated) which can move the carriage, together with the activation part/reception part unit 7 fitted to the latter, along the guide path 23 (arrow A).

The activation part 9 and the reception part 19 are arranged in such a manner that they essentially transmit and receive radially outward in a direction perpendicular to the guide path 23. By virtue of the fact that the guide path 23 runs along the longitudinal center of the ceiling of the room 5, the entire room 5 can thus be gradually repeatedly detected by the transmission/reception range of the activation part/reception part unit 7.

By virtue of the fact that, when the activation part/reception part unit 7 is moved along the guide path, the transponders 13 on the permanently installed objects 3 receive activation radio signals from the activation part 9 from different angles and also return code radiofrequency signals to the reception part 19 in the direction of different angles, a relative alignment—which is favorable for the correct transmission of signals—between the activation part/reception part unit 7 and the transponder 13 will be achieved with a very high degree of probability.

In this case, the data are preferably transmitted from the activation part/reception part unit 7 to a control device as described with reference to the first exemplary embodiment, the corresponding components not being described here.

The closed room 5 in the storage hall forms, together with the identification system 1 (which has been described and is provided in the latter) and the objects 3, an identification facility in accordance with a third embodiment of the invention.

The embodiments mentioned above represent only non restrictive examples of the invention, the scope of protection of which is defined by the appended claims. Modifications are therefore conceivable within the framework of the invention without departing from the scope of protection of the appended claims.

1-4. (canceled)

5. An identification system for identifying objects, comprising:
a plurality of objects to be identified, the objects being disposed within an area;
a transponder that is fitted to one respective object and operable to transmit a code radio frequency signal representing an identification code;
an activation part that is remote from the respective object and is operable to transmit an activation radio frequency signal via a wireless connection to the transponder of the respective object so that the transmitting part transmits the code radio frequency signal;
a receiving part that is remote from the respective object and is operable to receive the code radio frequency signal via a wireless connection; and
a device that is operable to move the activation part and receiving part within the area such that the two parts are moved continuously along a predetermined path which is in the form of circulatory path that is complementary to a shape of the area and to an arrangement of the objects in the area and such that activation part and the receiving part are moved past each respective object.

6. The identification system according to claim 5, wherein the reception part and the activation part are integrated form a single activation/reception unit.

7. The identification system according to claim 5, wherein the reception part and activation part are moved, in a controlled manner, along the predetermined path at a predetermined speed.

8. The identification system according to claim 7, wherein the speed of the activation part and of the reception part being less than or equal to 30 cm/s.

9. The identification system according to claim 7, wherein the speed of the activation part and of the reception part being less than or equal to 15 cm/s.

10. The identification system according to claim 7, wherein the speed of the activation part and of the reception part being less than or equal to 10 cm/s.

11. The identification system according to claim 5, wherein the area is within a closed room and the circulatory path is defined by an annular track with the objects being disposed radially outward from the annular track.

12. The identification system according to claim 5, wherein the transponder is coupled to the object and faces the activation part and reception part.

13. The identification system according to claim 5, wherein the device for moving the activation part and reception part includes a carriage that supports the activation part and the reception part and is driven along a pair of guide rails that define the predetermined circulatory path.

14. The identification system according to claim 5, wherein the area is within a closed room and the circulatory path is defined by an oval shaped track with the objects being disposed radially outward from the oval shaped track.

15. The identification system according to claim 5, wherein the objects are arranged radially outward from the circulatory path and movement of the activation part and the reception part results in the transponders of the objects receiving activation radio signals from respective activation parts from a first set of angles and the transponders return the code radio frequency signals to the respective reception parts at a second set of angles different from the first set of angles.

16. The identification system according to claim 5, wherein the activation part and the reception part are arranged in such that they transmit and receive, respectively, in opposite directions in a direction that is substantially perpendicular top the predetermined path.

17. The identification system according to claim 5, wherein the objects are stationary within the area.

18. An identification system for identifying objects, comprising: a plurality of objects to be identified, the objects being disposed within an area;
a transponder that is fitted to one respective object and operable to transmit a code radio frequency signal representing an identification code;
an activation part that is remote from the respective object and is operable to transmit an activation radio frequency signal via a wireless connection to the transponder of the respective object so that the transmitting part transmits the code radio frequency signal;
a receiving part that is remote from the respective object and is operable to receive the code radio frequency signal via a wireless connection; and
a device that is operable to move the activation part and receiving part within the area such that the two parts are moved continuously along a predetermined path which is in the form of a linear path that is complementary to a shape of the area and to an arrangement of the objects in the area, which are located along both sides of the linear path, and such that activation part and the receiving part are moved past each respective object.

19. A method for identifying objects, comprising the steps of:
attaching one transponder to each object to be identified;
providing an activation part, that can transmit an activation radio frequency signal, and a reception part, that can receive a code radio frequency signal;
transporting, in a continuous manner, the activation part and the reception part along a circulatory shaped path and past the objects;
transmitting an activation radio frequency signal from the activation part to the transponder via a wireless connection;
transmitting, by the transponder, the code radio frequency signal representing an identification code via a wireless connection;
receiving the code radio frequency signal at the reception part via a wire-free connection resulting in each respective object being identified.

20. An identification system for identifying a plurality of objects, comprising:
means for transmitting a code radio frequency signal representing an identification code, the transmitting means being configured to be coupled to each object;
activation means for transmitting an activation radio frequency signal via a wire-free connection to the transmitting means associated with one object to cause the transmitting means to transmit the code radio frequency signal;
means for receiving the code radio frequency signal via a wire-free connection; and
means for continuously transporting the means for activation and means for receiving past each object and along a circulatory path, with the objects being located radially outward from the transporting means.
